(19) United States
(12) Patent Application Publication
(10) Pub. No.: US 2013/0008430 A1
(43) Pub. Date: Jan. 10, 2013

(54) SOLAR COLLECTION APPARATUS AND STEAM GENERATOR USING THE SAME

(76) Inventor: Sang Chun Lee, Gyeongsangnam-Do (KR)

(21) Appl. No.: 13/635,242

(22) PCT Filed: Dec. 30, 2010
(86) PCT No.: PCT/KR10/09572

§ 371 Date: Sep. 14, 2012

(30) Foreign Application Priority Data
Mar. 16, 2010 (KR) 10-2010-0023244

(51) Int. Cl. F24J 2/46; F24J 2/52; G02B 5/10; F24J 2/10

(52) U.S. Cl. 126/600; 126/674; 126/684; 359/853

(57) ABSTRACT

Disclosed are a solar collection apparatus and a steam generator including the same. The solar collection apparatus includes a housing having an open upper surface; a dual glass plate coupled with the upper surface of the housing and formed therein with a storage space for receiving and storing water, in which solar light is transmitted through the dual glass plate; a first mirror fixed to a lower surface of the housing to collect and reflect the solar light transmitted through the dual glass plate; a second mirror fixed in the housing to reflect the solar light reflected from the first mirror; and an optical fiber having a first end located in the housing to receive the solar light reflected from the second mirror and a second end connected to a place of use to transmit the solar light to the place of use.

### TECHNICAL FIELD

The present invention relates to a solar collection apparatus and a steam generator using the same.

### BACKGROUND ART

In general, the solar collection schemes are divided into passive solar collection schemes for directly obtaining solar light through a window or the like in a place where the solar light is required and active solar collection schemes, in which the solar light obtained in a specific region is transferred to a place where the solar light is required.

Passive solar collection schemes may not be easily performed if obstacles, such as skyscrapers or multi-storied buildings are located around the window. Therefore, the active solar collection scheme is spotlighted.

The active solar collection schemes are classified into transmissive type solar collection schemes and reflective type solar collection schemes. According to the transmissive type solar collection scheme, the solar light transmitted through a lens or the like is collected in an optical fiber and the collected solar light is transferred to the place where the solar light is required. In addition, according to the reflective type solar collection scheme, the solar light reflected from a mirror or the like is collected in an optical fiber and the collected solar light is transferred to the place where the solar light is required.

The reflective type solar collection scheme is advantageous in that the light aberration is low and the light focus is relatively small. Thus, the light focus can be easily adjusted so that the solar light can be easily collected in an optical fiber having a small diameter. Besides the above advantages, the reflective type solar collection scheme is preferable to the transmissive type solar collection scheme in terms of the efficiency and economy. Therefore, the reflective type solar collection scheme is currently being extensively used.

However, according to the reflective type solar collection scheme of the prior art, the optical fiber may be damaged by high-temperature infrared rays if a great amount of solar light is introduced into the optical fiber, so there is restriction in the size of the light collection apparatus. In addition, since the reflective type solar collection scheme is dedicated for the purpose of lighting or heating, problems may occur in terms of efficiency.

### DISCLOSURE OF INVENTION

Technical Problem

Accordingly, the present invention has been made to solve the above-mentioned problems occurring in the prior art, and an object of the present invention is to provide a solar collection apparatus, which is not restricted in size, and a steam generator using the same.

Another object of the present invention is to provide a solar collection apparatus suitable for multi-purpose use and a steam generator using the same.

Solution to Problem

In order to accomplish the above objects, the present invention provides a solar collection apparatus including a housing having an open upper surface; a dual glass plate coupled with the upper surface of the housing and formed therein with a storage space for receiving and storing water, in which solar light is transmitted through the dual glass plate; a first mirror fixed to a lower surface of the housing to collect and reflect the solar light transmitted through the dual glass plate; a second mirror fixed in the housing to reflect the solar light reflected from the first mirror; and an optical fiber having a first end located in the housing to receive the solar light reflected from the second mirror and a second end connected to a place of use to transmit the solar light to the place of use.

The dual glass plate includes a first glass plate coupled with an inner peripheral surface of an upper portion of the housing and a second glass plate coupled with an inner peripheral surface of a lower portion of the housing below the first glass plate while being spaced apart from the first glass plate, and a sealing member is interposed between the first and second glass plates to form a closed space for storing the water by sealing a gap between the first and second glass plates.

The first glass plate is formed on an upper surface thereof with a dust prevention film and the second glass plate is formed on a lower surface thereof with an infrared cut-off film.

The first mirror includes a plurality of parabolic concave mirrors, a fixing groove is formed at the lower surface of the housing to fix the first mirror, the second mirror is formed on the lower surface of the second glass plate corresponding to the first mirror, and the first end of the optical fiber protrudes toward the second mirror by passing through the lower surface of the housing and a center of the first mirror.

The closed space defined between the first and second glass plates is communicated with an inlet pipe for receiving the water and an outlet pipe for discharging the water after the water introduced between the first and second glass plates is heated by the solar light, and the inlet and outlet pipes are provided therein with valves to open or close the inlet and outlet pipes.

The solar collection apparatus further includes a partition wall provided between the first and second glass plates to delay the water introduced through the inlet pipe before the water is discharged through the outlet pipe.

A plurality of partition walls are arranged in a zigzag configuration to divide the closed space formed between the first and second glass plates into several space sections communicated with each other, the partition walls are disposed perpendicularly to a movement route of the sun, and the first mirror, the second mirror and the optical fiber are disposed at lower portions of the space sections defined by the partition walls.

The partition walls includes a plurality of transverse partition walls and longitudinal partition walls that divide the closed space formed between the first and second glass plates into a lattice configuration such that the space sections are communicated with each other.

A cross part between the transverse partition wall and the longitudinal partition wall is lower than other parts of the transverse partition wall and the longitudinal partition wall.

The first end of the optical fiber disposed in the housing is tapered toward the second end of the optical fiber.

The solar collection apparatus further includes a driving unit having a motor and installed at one side of the housing to rotate the housing according to the movement route of the sun, and a solar cell installed in the housing to drive the motor.

According to another aspect of the present invention, there is provided a steam generator including a housing having an open upper surface and rotatably installed to move according to the movement route of the sun; a first glass plate coupled with an inner peripheral surface of an upper portion of the housing; a second glass plate coupled with an inner peripheral surface of a lower portion of the housing below the first glass plate to define a closed space to receive water between the first and second glass plates; a first mirror fixed to a lower surface of the housing to collect and reflect solar light transmitted through the first and second glass plates; a second mirror fixed to the lower surface of the housing to reflect the solar light reflected from the first mirror; an optical fiber having a first end located in the housing to receive the solar light reflected from the second mirror and a second end connected to a place of use to transmit the solar light to the place of use; a graphite member having a first side communicated with the closed space formed between the first and second glass plates, a second side communicated with another place of use, and an upper surface formed with a fluid path; a casing for protecting the graphite member by surrounding the graphite member; and a third mirror installed on the casing to reflect the solar light toward the fluid path of the graphite member.

The closed space defined between the first and second glass plates is communicated with an inlet pipe for receiving the water, a first side of the graphite member is communicated with the closed space through an outlet pipe, a second side of the graphite member is communicated with another place of use through a feeding pipe, and the inlet and outlet pipes are provided therein with valves to open or close the inlet and outlet pipes.

The steam generator further includes a partition wall provided between the first and second glass plates to delay the water introduced through the inlet pipe before the water is discharged through the outlet pipe.

The first glass plate is formed on an upper surface thereof with a dust prevention film and the second glass plate is formed on a lower surface thereof with an infrared cut-off film.

The first mirror includes a plurality of parabolic concave mirrors, a fixing groove is formed at the lower surface of the housing to fix the first mirror, the second mirror is formed on the lower surface of the second glass plate corresponding to the first mirror, the first end of the optical fiber protrudes toward the second mirror by passing through the lower surface of the housing and a center of the first mirror, and the first end of the optical fiber is tapered such that a diameter of the second end of the optical fiber is gradually increased toward the second mirror.

The steam generator further includes a transparent cover installed on the casing to protect the third mirror by surrounding the third mirror.

An upper surface of the casing is open, a holder having an open upper surface corresponding to the upper surface of the casing is installed in the casing, the graphite member is supported in the holder, and the third mirror is installed on an upper surface of the casing while being support by the holder.

Advantageous Effects of Invention

The solar collection apparatus and the steam generator using the same according to the present invention can block the infrared rays of the solar light by using water or water and the infrared cut-off filter so that visible rays having a relatively low temperature can be introduced into the optical fiber. Thus, the solar collection apparatus and the steam generator using the same according to the present invention can prevent the optical fiber from being damaged by the solar light and can be manufactured in a relatively large size.

In addition, according to the solar collection apparatus and the steam generator using the same of the present invention, the first to third mirrors and the graphite member are not exposed to the outside, so that the structure is stabilized and the configuration is simplified.

Further, the solar collection apparatus and the steam generator using the same according to the present invention can be used not only for the lighting by using the solar light collected in the optical fiber, but also for the heating by using water introduced between first and second glass plates to block the ultraviolet ray, and the heated water can be used to generate high-temperature steam, so the solar collection apparatus and the steam generator using the same according to the present invention can be used in various fields.

### BRIEF DESCRIPTION OF DRAWINGS

FIG. 1 is a partially-cut perspective view showing a solar collection apparatus according to one embodiment of the present invention;

FIG. 2 is a partially-cut perspective view showing a part of a solar collection apparatus according to one embodiment of the present invention;

FIG. 3 is a perspective view showing a part of a solar collection apparatus according to another embodiment of the present invention;

FIG. 4 is a perspective view showing a steam generator using a solar collection apparatus according to one embodiment of the present invention; and

FIG. 5 is a partially-cut perspective view showing a part of a steam generator using a solar collection apparatus according to one embodiment of the present invention.

### MODE FOR THE INVENTION

Hereinafter, exemplary embodiments of the present invention will be described in detail with reference to accompanying drawings. In the following description, description about known functions or known structures will be omitted if they make the subject matter of the present invention unclear.

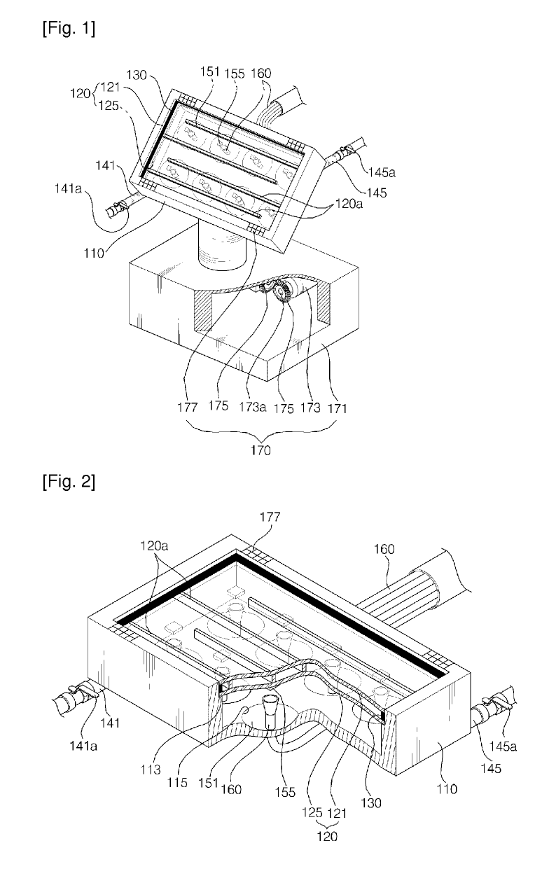

First, the structure of a solar collection apparatus according to one embodiment of the present invention will be described with reference to FIGS. 1 and 2.

FIG. 1 is a partially-cut perspective view showing the solar collection apparatus according to one embodiment of the present invention, and FIG. 2 is a partially-cut perspective view showing a part of the solar collection apparatus according to one embodiment of the present invention.

As shown in FIGS. 1 and 2, the solar collection apparatus according to the embodiment of the present invention includes a housing 110 having one open surface. A dual glass plate 120, a first mirror 121, a second mirror 125 and an optical fiber 160 are arranged in relation to the housing 110. In the following description, a surface or a direction directed upward of the housing 110 in the vertical direction will be referred to as “upper surface or upward direction” and a surface or a direction directed downward of the housing 110 in the vertical direction will be referred to as “lower surface or downward direction”.

The housing 110 has an open upper surface. The housing 110 is provided at an inner peripheral surface of an upper portion thereof with a storage space for receiving and storing purified water and the dual glass plate 120 is coupled with the inner peripheral surface of the housing 110 to allow the solar light to pass therethrough.

The dual glass plate 120 includes the first glass plate 121 coupled with an inner peripheral surface of an upper end of the housing 110 and the second glass plate 125 coupled with an inner peripheral surface of a lower end of the housing 110 below the first glass plate 121.

The first glass plate 121 is spaced apart from the second glass plate 125 and a sealing member 130 is interposed between the first and second glass plates 121 and 125 to form a closed space by sealing the gap between the first and second glass plates 121 and 125. In detail, the sealing member 130 is provided between the edge of the lower surface of the first glass plate 121 and the edge of the upper surface of the second glass plate 125 to seal the gap between the first and second glass plates 121 and 125.

A step portion 113 can be formed at an inner peripheral surface of the upper portion of the housing 110 to support the second glass plate 125.

The closed space defined between the first and second glass plates 121 and 125 is communicated with an inlet pipe and an outlet pipe 145, respectively. The water is introduced into the closed space formed between the first and second glass plates 121 and 125 through the inlet pipe 141, and the water introduced into the closed space is heated by the solar light reflected from the first and second mirrors 151 and 155 and then discharged to the outside through the outlet pipe 145.

The water stored in the closed space defined between first and second glass plates 121 and 125, which are silicate glass or borate glass, can be heated according to equation 1 expressed below.

Q=k(ΔT/L) [Equation 1]

(Q is calorie (W/m²), k is heat conductivity (W/mK) of first and second glass plates 121 and 125, L is thickness (m) of first and second glass plates 121 and 125, and ΔT is differential temperature between inner and outer sides of first and second glass plates 121 and 125).

Under the condition that the differential temperature between the inner and outer sides of the first and second glass plates 121 and 125 is almost 0, the thickness (m) of the first and second glass plates 121 and 125 can be set to 0.1 mm to 10 mm by taking into consideration the damage and the expansion coefficient of the first and second glass plates 121 and 125.

The water introduced between the first and second glass plates 121 and 125 is heated by absorbing the infrared ray of the solar light irradiated into the first and second glass plates 121 and 125. The visible ray of the solar light may transmitted through the first and second glass plates 121 and 125.

Valves 141a and 145a are installed in the inlet pipe 141 and the outlet pipe 145, respectively. The valves 141a and 145a open and close the inlet pipe 141 and the outlet pipe 145 to control the flow rate of water introduced into the closed space between the first and second glass plates 121 and 125 or discharged from the closed space.

The first mirror 151 is installed on a lower surface of the housing 110 to collect and reflect the solar light transmitted through the dual glass plate 120, and the second mirror 155 is installed on a lower surface of the second glass plate 125 corresponding to the first mirror 151 in the housing 110 to reflect the solar light reflected from the first mirror 151. The second mirror 155 reflects the solar light toward the first mirror 151.

The first mirror 151 may include a plurality of parabolic concave mirrors and a fixing groove 115 can be formed on the lower surface of the housing 110 to fix the first mirror 151 therein.

In addition, in order to collect and reflect the solar light at 20000 magnifications or more, the first mirror 151 has the diameter of about 20 cm or more and the second mirror 155 has the diameter of about 5 cm or less. That is a diameter ratio of the first mirror 151 to the second mirror 155 is 1:0.2 to 0.3.

One end of the optical fiber 160 is disposed in the housing 110 and the other end of the optical fiber 160 is connected to the place of use.

One end of the optical fiber 160 protrudes toward the second mirror 155 by passing through the bottom surface of the housing 110 and the center of the first mirror 151 and is located in the housing 110 to receive the solar light reflected from the second mirror 155.

At this time, in order to minimize the aberration of light received in the optical fiber 160 while facilitating the collection of the light in the optical fiber 160, the optical fiber 160 is tapered from one end to the other end. In detail, the diameter of one end of the optical fiber 160 is gradually increased toward the second mirror 155.

Meanwhile, since the infrared rays of the solar light have a high temperature, the optical fiber 160 may be damaged by the heat of the infrared rays.

However, according to the solar collection apparatus of the present invention, when the solar light is irradiated into the first and second glass plates 121 and 125, the infrared rays are introduced between the first and second glass plates 121 and 125 so that the infrared rays are absorbed in the water and the visible rays are transmitted through the first and second glass plates 121 and 125. Therefore, the optical fiber 160 can be prevented from being damaged by the infrared rays.

In order to protect the optical fiber 160 from the infrared rays, an infrared cut-off film (not shown) can be provided on the lower surface of the second glass plate 125.

That is, in the summer season subject to strong solar light, the infrared rays of the solar light are blocked by using the water and the infrared cut-off film. In addition, in the winter season, the infrared rays of the solar light are blocked by using the infrared cut-off film without supplying water between the first and second glass plates 121 and 125.

In addition, a dust prevention film (not shown) can be formed on the upper surface of the first glass plate 121 to prevent the solar light from being scattered by dust and the like.

The housing 110 must be rotated according to the movement route of the sun in order to allow the solar light to be concentrated onto the first mirror 151 through the dual glass plate 120.

To this end, a driving unit 170 is provided below the housing 110 to rotate the housing 110. The driving unit 170 includes a support plate 171, a motor 173 installed in the support plate 171, a plurality of gears 175 rotatably coupled with a shaft 173a of the motor 173 to rotate the housing 110, and a plurality of solar cells 177 for supplying power to drive the motor. That is, since the motor 173 is driven by the solar cells 177, the motor 173 can be independently driven without receiving power from the external power source.

In addition, a plurality of partition walls 120a are formed between the first and second glass plates 121 and 125. The partition walls 120a are arranged in a zigzag configuration to divide the closed space between the first and second glass plates 121 and 125 into several space sections communicated with each other.

In detail, a left side, an upper surface and a lower surface of one partition wall 120a make contact with the sealing member 130, the first glass plate 121 and the second glass plate 125, respectively, and a right side of the partition wall 120a is spaced part from the sealing member 130 to form a passage. In addition, a right side, an upper surface and a lower surface of the other partition wall 120a adjacent to the one partition wall 120a make contact with the sealing member 130, the first glass plate 121 and the second glass plate 125, respectively, and a left side of the partition wall 120a is spaced part from the sealing member 130 to form a passage.

Therefore, the water introduced between the first and second glass plates 121 and 125 through the inlet pipe 141 may flow through the space sections defined by the partition walls 120a and then introduced into the outlet pipe 145 so that the water is discharged to the outside. That is, since the water introduced between the first and second glass plates 121 and 125 is discharged to the outside after circulating through the first and second glass plates 121 and 125, the water can make contact with the solar light for a long period of time. Thus, the water may have a high temperature so that the high-temperature water can be discharged to the outside through the outlet pipe 145. The partition walls 120a may delay the flow of water introduced from the inlet pipe 141 before the water is discharged to the outside through the outlet pipe 145.

The inlet pipe 141 and the outlet pipe 145 are located in opposition to each other about the housing 110 and communicated with the dual glass plate 120, respectively. In addition, the partition walls 120a are arranged substantially perpendicular to the movement route of the sun. In addition, the first mirror 151, the second mirror 155 and the optical fiber 160 are provided at the lower portion of the space defined by the partition walls 120a.

Hereinafter, the operation of the solar collection apparatus having the above structure according to the present invention will be described with reference to FIGS. 1 and 2.

In a state in which the valve 141a is open and the valve 145a is closed, the purified water is introduced between the first and second glass plates 121 and 125. Thus, the infrared ray of the solar light irradiated into the first and second glass plates 121 and 125 is absorbed in the water stored between the first and second glass plates 121 and 125, so that the water is heated. In addition, the visible ray of the solar light is collected in the first mirror 151 and then reflected from the first mirror 151. The solar light reflected from the first mirror 151 is again reflected from the second mirror 155 so that the solar light is received in the optical fiber 160.

The solar light collected in the optical fiber 160 is transmitted through the optical fiber 160 so that the solar light can be used for the lighting and the like.

In addition, the water stored between the first and second glass plates 121 and 125 is heated while circulating through the space sections defined by the partition walls 120a. If the water is heated to a predetermined temperature suitable for the place of use, such as heating facilities, the valve 145a is open so that the water can be discharged to the place of use.

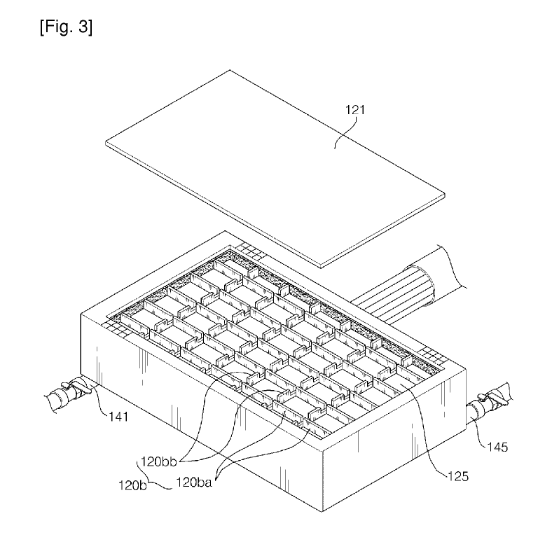

Hereinafter, the structure of a solar collection apparatus according to another embodiment of the present invention will be described with reference to FIG. 3.

FIG. 3 is a perspective view showing a part of the solar collection apparatus according to another embodiment of the present invention. The following description will be made by focusing on difference with respect to one embodiment of the present invention described with reference to FIG. 2 in order to avoid redundancy.

In the solar collection apparatus according to another embodiment of the present invention, each partition wall 120b includes a transverse partition wall 120ba and a longitudinal partition wall 120bb, which are arranged perpendicularly to each other between the first and second glass plates 121 and 125.

The partition walls 120b divide the space formed between the first and second glass plates 121 and 125 into a lattice configuration. In addition, the cross part between the transverse partition wall 120ba and the longitudinal partition wall 120bb is lower than other parts of the transverse partition wall 120ba and the longitudinal partition wall 120bb, so that space sections defined by the transverse partition wall 120ba and the longitudinal partition wall 120bb can be communicated with each other.

Due to the above structure, the water introduced between the first and second glass plates 121 and 125 through the inlet pipe 141 may be delayed by the partition walls 120b before the water is discharged to the outside through the outlet pipe 145. Thus, the water introduced through the inlet pipe 141 may have relatively high temperature and the high-temperature water is discharged to the outside.

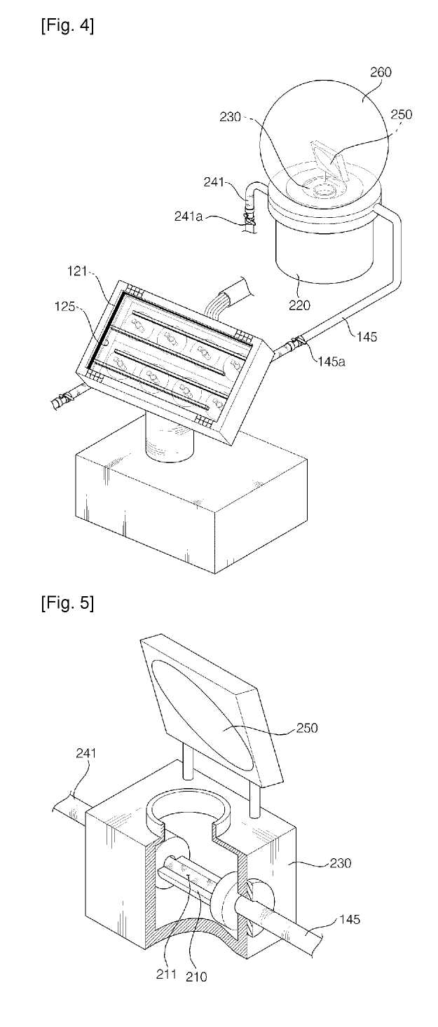

Hereinafter, the structure of a steam generator using the solar collection apparatus according to one embodiment of the present invention will be described with reference to FIG. 4 or 5.

FIG. 4 is a perspective view showing the steam generator using the solar collection apparatus according to one embodiment of the present invention and FIG. 5 is a partially-cut perspective view showing a part of the steam generator using the solar collection apparatus according to one embodiment of the present invention.

The solar collection apparatus used in the steam generator may be the solar collection apparatus shown in FIG. 1, 2 or 3. For the purpose of convenience of explanation, the following description will be made on the assumption that the solar collection apparatus shown in FIG. 1 or 2 is used in the steam generator.

As shown in FIGS. 4 and 5, the steam generator using the solar collection apparatus according to the embodiment of the present invention includes a graphite member 210.

The graphite member 210 has a semicircular sectional shape, and a fluid path 211 is formed on a flat upper surface of the graphite member 210. The fluid path 211 is recessed downward to guide the flow of water.

The graphite member 210 is protected while being surrounded by a casing 220, in which the center of the upper surface of the casing 220 is open. At this time, the upper surface of the graphite member 210 is located very below the center of the upper surface of the casing 220. The graphite member 210 is supported by a holder 230 installed in the casing 220. The center of the upper surface of the holder 230 is open corresponding to the center of the upper surface of the casing 220.

One side of the graphite member 210 is communicated with the outlet pipe 145 extending by passing through one side of the casing 220 and the holder 230 and the other side of the graphite member 210 is communicated with the place of use via a feeding pipe 241 extending by passing through the other side of the casing 220 and the holder 230. A valve 241a is installed in the feeding pipe 241 to open or close the feeding pipe 241.

A third mirror 250 is provided at the upper portion of the casing 220 to reflect the solar light toward the fluid path 211 of the graphite member 210. The third mirror 250 is supported by the holder 230. The water supplied into the fluid path 211 of the graphite member 210 is heated so that the water is converted into the steam having the high temperature and the high-temperature steam is supplied to the place of use through the feeding pipe 241.

In addition, a transparent cover 260 is provided on the upper surface of the casing 220 to protect the third mirror 250 from external impact while preventing impurities from penetrating into the casing 220.

Hereinafter, the operation of the steam generator having the above structure according to the embodiment of the present invention will be described with reference to FIGS. 3 and 4.

As shown in FIGS. 3 and 4, if the water introduced into the closed space defined between the first and second glass plates 121 and 125 is heated to the temperature of about 80° C. to about 90° C. , the valve 145a of the outlet pipe 145 is open.

Thus, the heated water is introduced into the fluid path 211 of the graphite member 210 and the water is heated again in the fluid path 211 by the solar light reflected from the third mirror 250. At this time, the water may be rapidly heated in the fluid path 211 due to the property of the graphite member 210, so that the water is converted into the steam.

If the steam has a desired temperature, the valve 241a is open so that the steam is supplied to the place of use. For instance, if steam is supplied to the place of use for generating oxygen, the high-temperature steam is reacted with CO2 generated in the high temperature condition in the place of use, thereby generating oxygen.

The solar collection apparatus and the steam generator using the same according to the embodiment of the present invention can block the infrared rays of the solar light by using the water and the infrared cut-off filter, so the solar light transmitting through the first and second glass plates 121 and 125 is in the form of visible rays. Therefore, the solar light collected in the optical fiber 160 while being reflected from the first and second glass plates 121 and 125 is in the form of visible rays having a relatively low temperature, so that the optical fiber 160 can be prevented from being damaged by the solar light. Since the optical fiber 160 can be prevented from being damaged by the solar light, the solar collection apparatus and the steam generator using the same according to the embodiment of the present invention can be manufactured in a large size.

In addition, the solar light transmitted through the optical fiber 160 can be used for the purpose of lighting, and the water heated in the closed space between the first and second glass plates 121 and 125 can be used for the purpose of heating. In addition, if the water is heated again in the graphite member 210 by using the solar light, the water can be converted into steam having a high temperature. Thus, the solar collection apparatus and the steam generator using the same according to the present invention can be used in various fields.

Further, according to the solar collection apparatus and the steam generator using the same of the present invention, the first to third mirrors 151, 152 and 250, the optical fiber 160 and the graphite member 210 are not exposed to the outside, so that the structure is stabilized and the configuration is simplified.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A solar collection apparatus comprising:
a housing having an open upper surface;
a dual glass plate coupled with the upper surface of the housing and formed therein with a storage space for receiving and storing water, in which solar light is transmitted through the dual glass plate;
a first mirror fixed to a lower surface of the housing to collect and reflect the solar light transmitted through the dual glass plate;
a second mirror fixed in the housing to reflect the solar light reflected from the first mirror; and
an optical fiber having a first end located in the housing to receive the solar light reflected from the second mirror and a second end connected to a place of use to transmit the solar light to the place of use.

2. The solar collection apparatus as claimed in claim 1, wherein the dual glass plate includes a first glass plate coupled with an inner peripheral surface of an upper portion of the housing and a second glass plate coupled with an inner peripheral surface of a lower portion of the housing below the first glass plate while being spaced apart from the first glass plate, and a sealing member is interposed between the first and second glass plates to form a closed space for receiving and storing the water by sealing a gap between the first and second glass plates.

3. The solar collection apparatus as claimed in claim 2, wherein the first glass plate is formed on an upper surface thereof with a dust prevention film and the second glass plate is formed on a lower surface thereof with an infrared cut-off film.

4. The solar collection apparatus as claimed in claim 2, wherein the first mirror includes a plurality of parabolic concave mirrors, a fixing groove is formed at the lower surface of the housing to insert and fix the first mirror, the second mirror is installed on the lower surface of the second glass plate corresponding to the first mirror, and the first end of the optical fiber protrudes toward the second mirror by passing through the lower surface of the housing and a center of the first mirror.

5. The solar collection apparatus as claimed in claim 2, wherein the closed space defined between the first and second glass plates is communicated with an inlet pipe for receiving the water and an outlet pipe for discharging the water after the water introduced between the first and second glass plates is heated by the solar light, and the inlet and outlet pipes are provided therein with valves to open or close the inlet and outlet pipes.

6. The solar collection apparatus as claimed in claim 5, further comprising a partition wall provided between the first and second glass plates to delay the water introduced through the inlet pipe before the water is discharged through the outlet pipe.

7. The solar collection apparatus as claimed in claim 6, wherein a plurality of partition walls are arranged in a zigzag configuration to divide the closed space formed between the first and second glass plates into several space sections communicated with each other, the partition walls are disposed perpendicularly to a movement route of the sun, and the first mirror, the second mirror and the optical fiber are disposed at lower portions of the space sections defined by the partition walls.

8. The solar collection apparatus as claimed in claim 7, wherein the partition walls include a plurality of transverse partition walls and longitudinal partition walls that divide the closed space formed between the first and second glass plates into a lattice configuration such that the space sections are communicated with each other.

9. The solar collection apparatus as claimed in claim 8, wherein a cross part between the transverse partition wall and the longitudinal partition wall is lower than other parts of the transverse partition wall and the longitudinal partition wall.

10. The solar collection apparatus as claimed in claim 1, wherein the first end of the optical fiber disposed in the housing is tapered toward the second end of the optical fiber.

11. The solar collection apparatus as claimed in claim 1, further comprising a driving unit including a motor installed at one side of the housing to rotate the housing according to the movement route of the sun, and a solar cell installed in the housing to drive the motor.

12. A steam generator comprising:
a housing having an open upper surface and rotatably installed to move according to the movement route of the sun;
a first glass plate coupled with an inner peripheral surface of an upper portion of the housing;
a second glass plate coupled with an inner peripheral surface of a lower portion of the housing below the first glass plate to define a closed space to receive water between the first and second glass plates;
a first mirror fixed to a lower surface of the housing to collect and reflect solar light transmitted through the first and second glass plates;
a second mirror fixed to the lower surface of the housing to reflect the solar light reflected from the first mirror;
an optical fiber having a first end located in the housing to receive the solar light reflected from the second mirror and a second end connected to a place of use to transmit the solar light to the place of use;
a graphite member having a first side communicated with the closed space formed between the first and second glass plates, a second side communicated with another place of use, and an upper surface formed with a fluid path;
a casing for protecting the graphite member by surrounding the graphite member; and a third mirror installed on the casing to reflect the solar light toward the fluid path of the graphite member.

13. The steam generator as claimed in claim 12, wherein the closed space defined between the first and second glass plates is communicated with an inlet pipe for receiving the water, a first side of the graphite member is communicated with the closed space through an outlet pipe, a second side of the graphite member is communicated with another place of use through a feeding pipe, and the inlet and outlet pipes are provided therein with valves to open or close the inlet and outlet pipes.

14. The steam generator as claimed in claim 13, further comprising a partition wall provided between the first and second glass plates to delay the water introduced through the inlet pipe before the water is discharged through the outlet pipe.

15. The steam generator as claimed in claim 12, wherein the first glass plate is formed on an upper surface thereof with a dust prevention film and the second glass plate is formed on a lower surface thereof with an infrared cut-off film.

16. The steam generator as claimed in claim 12, wherein the first mirror includes a plurality of parabolic concave mirrors, a fixing groove is formed at the lower surface of the housing to insert and fix the first mirror, the second mirror is installed on the lower surface of the second glass plate corresponding to the first mirror, the first end of the optical fiber protrudes toward the second mirror by passing through the lower surface of the housing and a center of the first mirror, and the first end of the optical fiber is tapered such that a diameter of the second end of the optical fiber is gradually increased toward the second mirror.

17. The steam generator as claimed in claim 12, further comprising a transparent cover installed on the casing to protect the third mirror by surrounding the third mirror.

18. The steam generator as claimed in claim 12, wherein an upper surface of the casing is open, a holder having an open upper surface corresponding to the upper surface of the casing is installed in the casing, the graphite member is supported in the holder, and the third mirror is installed on an upper surface of the casing while being supported by the holder.
